(19) United States
(12) Patent Application Publication
(10) Pub. No.: US 2017/0210090 A1
(43) Pub. Date: Jul. 27, 2017

(54) METAL FOAM STACK AND MANUFACTURING METHOD THEREFOR

(71) Applicant: ALANTUM, Seongnam-si (KR)

(72) Inventors: Jong Kwang KIM, Seoul (KR); Byoung Kwon CHOI, Daejeon (KR); Myung Joon JANG, Incheon (KR)

(21) Appl. No.: 15/326,686

(22) PCT Filed: Aug. 7, 2015
(86) PCT No.: PCT/KR2015/008306

§ 371 Date: Jan. 17, 2017

(30) Foreign Application Priority Data
Aug. 7, 2014 (KR) 10-2014-0101919

(51) Int. Cl. B32B 5/18; B23K 20/22; B22F 1/00; B32B 37/10; B32B 37/06; B22F 3/10; B23K 20/02; B32B 15/04

(52) U.S. Cl. CPC B32B 5/18; B23K 20/026; B23K 20/22; B32B 15/043; B32B 37/10; B32B 37/06; B22F 3/1021; B22F 1/0003; B23K 2203/12

(57) ABSTRACT

Provided are a metal foam stack and a manufacturing method thereof. The metal foam stack includes one or more stack units. The stack unit includes: a first metal foam sheet including an open cell, in which a plurality of internal cells is connected with one another; a first bonding member positioned on the first metal foam sheet; and a second metal foam sheet positioned on the first bonding member, and including an open cell, in which a plurality of internal cells is connected with one another. Materials of an interface between the first metal foam sheet and the first bonding member and an interface between the second metal foam sheet and the first bonding member are atomically diffused.

### TECHNICAL FIELD

The present invention relates to a metal foam stack and a manufacturing method thereof.

### BACKGROUND ART

In general, metal foam refers to porous metal having a large amount of bubbles inside a metal material.

The metal foam is divided into an open cell type or a closed cell type according to a shape of a bubble included therein. In the open cell type, the bubbles are present in a connected form, and it is easy for gas or a fluid to pass through along the bubbles. However, in the closed cell type, the bubbles are not connected with one another and are independently present, and it is not easy for gas or a fluid to pass through along the bubbles.

Since the metal form in the open cell type has a similar structure to that of a bone of a human body, so that a structure thereof is stable, and has a physical property in that the metal form has an extremely large ratio of a surface area to a unit volume and is light, so that the metal form in the open cell type may be used for various usages.

The metal foam is used in various industrial fields, such as an electrode of a battery, a component of a fuel cell, a filter for a particulate filtering apparatus, a contamination control device, a catalyst supporter, and an audio component.

However, in the related art, in order to manufacture the metal foam stack, a process of simply laminating metal foam and metal foam and then sintering is performed, so that contraction may be seriously generated in a center portion and a lateral portion of the manufactured metal foam stack. Accordingly, a porous structure may be destroyed and it may be difficult to manufacture a metal foam stack having a desired thickness.

### DISCLOSURE

### Technical Problem

The present invention has been made in an effort to provide a high quality metal foam stack, in which destruction of a porous structure is minimized and which is controlled to have a desired thickness.

The present invention has also been made in an effort to provide a method of manufacturing a metal foam stack, which may minimize destruction of a porous structure and which may manufacture a metal foam stack with a desired thickness.

### Technical Solution

In order to implement other problems that are not mentioned in detail in addition to the above problems, an exemplary embodiment according to the present invention may be used.

An exemplary embodiment of the present invention provides a metal foam stack, including one or more stack units, in which the stack unit includes: a first metal foam sheet including an open cell, in which a plurality of internal cells is connected with one another; a first bonding member positioned on the first metal foam sheet; and a second metal foam sheet positioned on the first bonding member, and including an open cell, in which a plurality of internal cells is connected with one another.

Materials of an interface between the first metal foam sheet and the first bonding member and an interface between the second metal foam sheet and the first bonding member may be atomically diffused.

The first bonding member may include at least one of metal powder and brazing foil.

The number of stack units may be two or more, and the metal foam stack may include: a first stack unit; a second bonding member positioned on the first stack unit; and a second stack unit positioned on the second bonding member, and the second bonding member may include at least one of metal powder, brazing foil, a ceramic bond, and a metal glue.

The first metal foam sheet or the second metal foam sheet may include one or more of an Ni-based metal foam, a Fe-based metal foam, and a Cu-based metal foam.

The metal powder may be alloy powder, and may include nickel (Ni) of about 15 wt % or more or chrome (Cr) of about 20 wt % or more.

Another exemplary embodiment of the present invention provides a metal foam stack, including one or more stack units, in which the stack unit includes: a first metal foam sheet including an open cell, in which internal cells are connected with one another; a first bonding member positioned on the first metal foam sheet; a heterogeneous member positioned on the first bonding member; a first bonding member positioned on the heterogeneous member; and a second metal foam sheet positioned on the first bonding member, and including an open cell, in which internal cells are connected with one another, and the heterogeneous member may be a different shape or include a different material from shapes and materials of the first metal foam sheet and the second metal foam sheet.

Still another exemplary embodiment of the present invention provides a metal foam stack, including two or more stack units, in which the stack unit includes: a first metal foam sheet including an open cell, in which internal cells are connected with one another; a first bonding member positioned on the first metal foam sheet; and a second metal foam sheet positioned on the first bonding member, and including an open cell, in which internal cells are connected with one another, and the metal foam stack includes a first stack unit, a second bonding member positioned on the first stack unit, a heterogeneous member positioned on the second bonding member, a second bonding member positioned on the heterogeneous member, and a second stack unit positioned on the second bonding member, and the heterogeneous member has a different shape or includes a different material from shapes and materials of the first metal foam sheet and the second metal foam sheet.

Yet another exemplary embodiment of the present invention provides a method of manufacturing a metal foam stack, including: preparing a first metal foam sheet and a second metal foam sheet, each of which includes an open cell, in which internal cells are connected with one another; forming a metal foam stack including one or more stack units by positioning a first bonding member between the first metal foam sheet and the second metal foam sheet; applying external pressure to the metal foam stack; and performing a heat treatment by heating the metal foam stack.

The first bonding member may include at least one of metal powder, slurry including metal powder, and brazing foil.

Still yet another exemplary embodiment of the present invention provides a method of manufacturing a metal foam stack, including: preparing a first stack unit and a second stack unit; forming a metal foam stack including two or more stack units by positioning a second bonding member between the first stack unit and the second stack unit; applying external pressure to the metal foam stack; and performing a heat treatment by heating the metal foam stack.

The second bonding member may include at least one of metal powder, slurry including metal powder, brazing foil, a ceramic bond, and a metal glue.

The method may further include applying pre-press to the metal foam stack and removing the pre-press before the applying of the external pressure.

The applying of the external pressure and the performing of the heat treatment may be simultaneously performed.

The metal powder may be alloy powder, and may include nickel (Ni) of about 15 wt % or more or chrome (Cr) of about 20 wt % or more.

The slurry including the metal powder may be slurry for bonding, and the metal powder of the slurry for bonding may include chrome (Cr) of about 30 wt % or more, molybdenum (Mo) of about 15 wt % or more, or niobium (Nb) of about 3 wt % or more.

The first metal foam sheet or the second metal foam sheet may include one or more of Ni-based metal foam, Fe-based metal foam, and Cu-based metal foam.

The applying of the external pressure may include: disposing a plate on an upper surface of a metal foam sheet positioned at an uppermost portion of the metal foam stack; and disposing a loading member on the plate so as to load an entire section of the plate.

The plate may be formed of a material including one or more of molybdenum (Mo), titanium (Ti), stainless steel, and a ceramic block.

The performing of the heat treatment may include: performing debinding of removing a binder ingredient from the metal foam stack; and sintering the metal foam stack.

The debinding may be performed at about 500° C. to about 600° C. for one to two hours.

The sintering may be performed at about 1,100 to 1,300° C. for about one to two hours.

### Advantageous Effects

According to the metal foam stack and the method of manufacturing the same according to the exemplary embodiment of the present invention, it is possible to provide the high quality metal foam stack, in which destruction of a porous structure is minimized and which is controlled to have a desired thickness.

### DESCRIPTION OF THE DRAWINGS

FIG. 1 is a picture of a metal foam sheet including an open cell type.

FIG. 2 is a schematic diagram illustrating a metal foam stack according to an exemplary embodiment of the present invention.

### MODE FOR INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

It will be understood that when an element is referred to as being “on” or “over” another element, it can be directly on the other element or intervening elements may also be present. Contrary to this, when an element is referred to as being “directly on” another element, intervening elements are not present.

The terminologies used herein are set forth to illustrate a specific exemplary embodiment, and do not intend to limit the present invention. It should be noted that, as used in the specification and the appended claims, the singular forms include plural references unless the context clearly dictates otherwise. It will be further understood that the terms “comprises” and/or “comprising,” when used in this specification, specify the presence of stated properties, regions, integers, steps, operations, elements, and/or components, but do not preclude the presence or addition of one or more other properties, regions, integers, steps, operations, elements, components, and/or groups.

Terms, such as “under” and “on”, representing a relative space may be used for more easily explaining a relation of one part with respect to another part illustrated in the drawing. The terms are intended to include other meanings or operations of a device, which is being used, together with an intended meaning in the drawings.

In the specification of the present invention, “a first” or “a second” does not mean only the different type of material and composition, and in the configuration of the entire invention, even though the materials and the compositions are the same, the term may be used as a meaning for discriminating a position of a configuration described after “a first” or “a second”.

Unless they are not defined, all terms including technical terms and scientific terms used herein have the same meaning as the meaning generally understood by the person with ordinary skill in the art to which the present invention belongs. The commonly used terminologies that are defined a dictionary are further interpreted to have the meaning that coincides with the contents that are disclosed in relating technical documents and the currently disclosed, but not as the ideal or very official meaning unless they are not defined.

Metal foam may be divided into an open type or a closed type according to whether a cell or a pore formed inside the metal foam is closed or opened, and metal foam according to an exemplary embodiment of the present invention is open type metal foam.

A process of manufacturing the open type metal foam will be described below. A conductive porous body is prepared by depositing titanium or a titanium alloy on a surface of an organic porous body by using electroplating. A metal is electroplated on a surface of the conductive porous body by making a metal electroplating solution pass through the conductive porous body. An organic porous body component is removed by heat treating the metal plated conductive porous body.

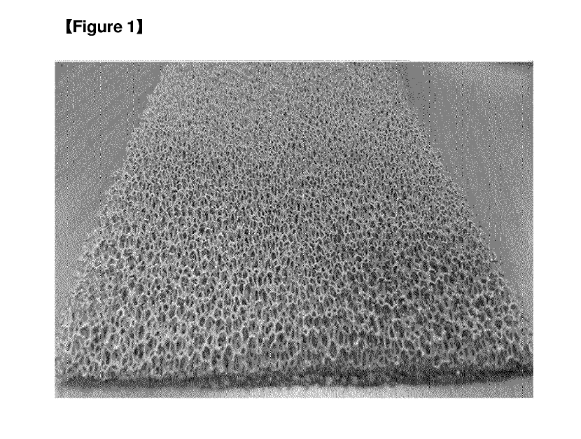

FIG. 1 is a picture of a metal foam sheet including an open cell type. Referring to FIG. 1, in the open cell type, cells or pores inside the metal foam are connected with one another in an irregular shape, and gas or a fluid more easily passes through the metal foam. The metal foam may be a sheet shape cut in a predetermined size, and may be formed in a quadrangular shape, but is not limited thereto, and may be formed in various shapes. Further, polyurethane may be used as the organic porous body of the metal foam. Further, the metal foam sheet may be formed with a thickness of a maximum of about 10 mm or less, for example, about 1.6 mm to 3.0 mm.

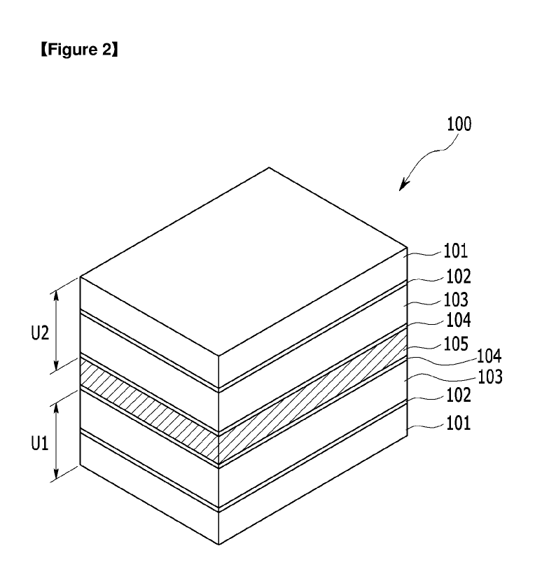

FIG. 2 is a schematic diagram illustrating a metal foam stack 100 according to an exemplary embodiment of the present invention.

Referring to FIG. 2, the metal foam stack 100 according to the exemplary embodiment of the present invention includes one or more stack units U1 and U2 including a first metal foam sheet 101 including an open type cell, in which internal cells are connected with one another therein, a first bonding member 102 positioned on the first metal foam sheet 101, and a second metal foam sheet 103 positioned on the first bonding member 102 and including an open type cell, in which internal cells are connected with one another therein.

In this case, the material forming the first bonding member 102 is diffused between the first metal foam sheet 101 and the second metal foam sheet 103 in a solid phase. Interfaces between the first metal foam sheet 101, the second metal foam sheet 103, and the first bonding member 102 may include a material in a form mixed in an atomistic level. A material forming the first bonding member 102 positioned between the first metal foam sheet 101 and the second metal foam sheet 103 may be atomically diffused for the first metal foam sheet 101 and the second metal foam sheet 103 while passing through a heat treatment process according to a manufacturing operation. In this case, the materials forming the interface of the first metal foam sheet 101 and the first bonding member 102 and the interface of the second metal foam sheet 103 and the first bonding member 102 may have forms diffused in the atomistic level by the heat treatment, so that bonding force between the first and second metal foam sheets 101 and 103 may be increased.

The first bonding member 102 may include at least one of metal powder and brazing foil.

The number of stack units U1 and U2 may be two or more.

The metal foam stack 100 includes the first stack unit U1, the second bonding member 104 positioned on the first stack unit U1, and the second stack unit U2 positioned on the second bonding member 104.

The second bonding member 104 includes at least one of metal powder, brazing foil, a ceramic bond, and metal glue.

The first metal foam sheet 101 or the second metal foam sheet 103 may include one or more among Ni-based metal foam, Fe-based metal foam, and Cu-based metal foam.

The metal powder is alloy powder, and includes nickel (Ni) of about 15 wt % or more or chrome (Cr) of about 20 wt % or more.

In the stack unit of the metal foam stack, the bonding member and a heterogeneous member may be sequentially positioned between the pair of metal foam sheets including the open type cells connected with one another inside the stack unit, and one or more stack units may be piled to form the metal foam stack.

The metal foam stack 100 according to the exemplary embodiment of the present invention may include the first stack unit U1, the second bonding member 104 positioned on the first stack unit U1, a heterogeneous member 105 positioned on the second bonding member 104, the second bonding member 104 positioned on the heterogeneous member 105, and the second stack unit U2 positioned on the second bonding member 104.

The heterogeneous member 105 may have a shape or a material different from those of the first metal foam sheet 101 and the second metal foam sheet 103. For example, the heterogeneous member 105 may be formed of a stainless steel material. The heterogeneous member 105 may be used for improving thermal or electric conductivity through metallic bonding with the metal foam sheet. The metal foam itself has high thermal or electric conductivity, but it is impossible to increase a bonding area between the metal foams only with the general bonding using an adhesive and the like, so that when the metal foams are bonded by the general bonding, thermal or electric conductivity between the metal foams may be sharply degraded. Further, the heterogeneous member 105 may be a protective material for preventing the metal foam sheet from being destroyed or damaged.

Average tensile strength in a direction of a lamination height of the metal foam stack 100 is different according to an application field, but as the tensile strength is high, the metal foam stack 100 may have resistance for strong external stress and may maintain a predetermined shape.

A method of manufacturing the metal foam stack according to an exemplary embodiment of the present invention includes an operation of preparing a first metal foam sheet and a second metal foam sheet, which include open type cells connected with one another inside thereof, an operation of forming the metal foam stack including one or more stack units by positioning a first bonding member between the first metal form sheet and the second metal foam sheet, an operation of applying external pressure to the metal foam stack, and an operation of performing a heat treatment for heating the metal foam stack.

Hereinafter, overlapping contents to the aforementioned contents will be omitted.

Hereinafter, the method of manufacturing the metal foam stack according to the exemplary embodiment of the present invention will be described in detail according to each operation.

First, the first metal foam sheet and the second metal foam sheet, each of which includes open type cells, in which internal cells are connected with one another, are prepared. The first metal foam sheet or the second metal foam sheet may include one or more among Ni-based metal foam, Fe-based metal foam, and Cu-based metal foam.

Next, the metal foam stack including one or more stack units is formed by positioning the first bonding member between the first metal foam sheet and the second metal foam sheet. Here, the first bonding member may include at least one of metal powder, slurry including metal powder, and brazing foil.

The metal powder is alloy powder, and includes nickel (Ni) of about 15 wt % or more or chrome (Cr) of about 20 wt % or more.

The slurry including the metal powder is slurry for bonding, and the metal powder of the slurry for bonding may include chrome (Cru) of about 30 wt % or more, molybdenum (Mo) of about 15 wt % or more, or niobium (Nb) of about 3 wt % or more. The slurry for bonding is alloy powder having a lower melting point than that of the general slurry, and may be used for the purpose of bonding the metal foam sheet.

The slurry including the metal powder may be positioned between the first metal foam sheet and the second metal foam sheet by being directly applied onto the metal foam sheet or dipping the metal foam sheet into the slurry. The metal powder included in the slurry may secure a good sintering contact between the metal foam sheets, and may be used for alloying. Before positioning the slurry including the metal powder, the metal powder of the slurry and a binder may be mixed by a mixer. In this case, a liquid, such as water, may be further added for easily mixing the powder and the binder.

Next, the operation of applying the external pressure to the metal foam stack is an operation of applying external pressure onto at least one surface of the metal foam stack in order to improve bonding force between the respective layers after closely contacting the respective layers and performing the heat treatment on the layers before the heat treatment of the metal foam stack.

The operation of applying the external pressure may include an operation of disposing a plate on an upper surface of the metal foam sheet positioned at the topmost portion in the metal foam stack, and an operation of disposing a loading member on the plate so as to load the entire sections of the plate. When the plate is in contact with the metal foam sheet, the plate may be a material having low reactivity. For example, the plate may be a material including one or more of molybdenum (Mo), titanium (Ti), stainless steel, and a ceramic block. Molybdenum (Mo) or titanium (Ti) has low reactivity, so that it is possible to prevent a reaction with the contacting metal foam during sintering. When the external pressure is applied to the metal foam stack in the operation of applying the external pressure, the loading member may pressurize the metal foam stack with a pressure of about 3 to 4 g/cm² so that a thickness of the metal foam stack may be decreased within the range of about 5 to 10%. A high compression ratio is advantageous to sufficient bonding strength of the metal foam stack. Weight of the loading member has a predetermined size, but may be variously changed according to a compression ratio of the metal foam stack.

Before the operation of applying the external pressure, an operation of applying pre-pressure to the metal foam stack and removing the pre-pressure may be performed. Herein, the application of the pre-pressure may be performed for a relatively short time compared to a time of the operation of applying the external pressure, and may be performed by a press machine. Through the application and the removal of the pre-press, bonding force between the respective layers may be further improved after the heat treatment operation.

Next, the operation of performing the heat treatment for heating the metal foam stack is an operation of heating the metal foam stack so that the first and second metal foam sheets are stably bonded through the first bonding member according to the atomic diffusion of the material of the first bonding member positioned between the first and second metal foam sheets.

The operation of applying the external pressure and the operation of performing the heat treatment may be simultaneously performed. When the operation of applying the external pressure and the operation of performing the heat treatment are simultaneously performed, bonding force between the layers of the manufactured metal foam stack may be further improved compared to the case where the operation of applying the external pressure and the operation of performing the heat treatment are separately performed.

The operation of performing the heat treatment may include an operation of performing debinding for removing a binder component from the metal foam stack, and an operation of sintering the metal foam stack.

The operation of performing the debinding may be performed for about one to two hours at about 500 to 600° C. Within the temperature range, the binder may be efficiently removed. Further, within the time range, the binder may be efficiently removed.

The operation of performing the sintering may be performed for about one to two hours at about 1,100 to 1,300° C. Within the temperature range, strong bonding between the metal foam sheet and the bonding member or the heterogeneous member may be efficiently bonded. Further, within the time range, strong bonding between the metal foam sheet and the bonding member or the heterogeneous member may be efficiently formed.

A method of manufacturing a metal foam stack according to an exemplary embodiment of the present invention includes an operation of preparing a first stack unit and a second stack unit, an operation of forming a metal foam stack including two or more stack units by positioning a second bonding member between the first stack unit and the second stack unit, an operation of applying external pressure to the metal foam stack, and an operation of performing a heat treatment for heating the metal foam stack.

The second bonding member may include at least one of metal powder, slurry including metal powder, brazing foil, a ceramic bond, and a metal glue.

Descriptions for the operation of applying external pressure to the metal foam stack, and the operation of performing the heat treatment for heating the metal foam stack are the same as those of the aforementioned contents, so that the descriptions will be omitted below.

Hereinafter, the present invention will be described in more detail with reference to Examples, but the following Examples are Examples of the present invention, and the present invention is not limited by the following Examples.

### <Example 1>—Manufacture Metal Foam Stack

First, two metal foam sheets made of a material of NiCrAl and having a pore size of about 1,200 μm are prepared. Each of a horizontal length and a vertical length of the metal foam sheet is about 280 mm. Next, a binder solution, in which polyethyleneimine (Lupasol) of about 25 g and water of about 1 kg are mixed, is coated on a surface of one metal foam sheet by a spray method. Subsequently, metal powder of NiCrAl is coated by the spray method. Next, pre-pressure is applied to the formed metal foam stack by using a press machine so that the metal foam stack is pressurized to have about 20% of an initial thickness of the metal foam stack. Next, the pressure applied during the application of the pre-pressure is removed, and pressure is applied by a method of laying a metal plate (molybdenum or ceramic block) having predetermined weight on the metal foam stack again and a heat treatment is simultaneously performed at 1,280° C., to manufacture the metal foam stack, of which each of a horizontal length and a vertical length is about 280 mm.

### <Comparative Example 1>—Manufacture Metal Foam Stack

A metal foam stack is manufactured by performing the same method as that of Example 1 except that pre-pressure is not applied.

### <Comparative Example 2>—Manufacture Metal Foam Stack

A metal foam stack is manufactured by performing the same method as that of Example 1 except that a heat treatment is performed without applying pressure through a loading member.

### <Experimental Example 1>—Measure Tensile Strength

In order to measure tensile strength in a stack direction, an experiment is performed on the metal foam stacks manufactured in Example 1 and Comparative Examples 1 and 2 by a method described below.

Each of the metal foam stacks having the horizontal length and the vertical length of 280 mm manufactured in Example 1 and Comparative Examples 1 and 2 is notched by using a band saw to have the horizontal length and the vertical length of about 400 mm. By the method, 49 samples are prepared. Tensile strength is measured for the cut samples by about 49 times by using a universal testing machine (UTM), and an average value thereof is referred to as bonding strength.

Referring to Table 1 below, Example 1 including the operation of applying the pre-pressure or the operation of applying pressure through the loading member represents more excellent average tensile strength than those of Comparative Examples 1 and 2.

TABLE 1

| | | | Average tensile |
|---|---|---|---|
| | Process condition | | strength (kgf) |
| Example 1 | Apply pre-pressure, | 1,280° C. | 185 |
| | Use loading member | | |
| Comparative | Apply no pre-pressure, | 1,280° C. | 99 |
| Example 1 | Use loading member | | |
| Comparative | Apply pre-pressure, | 1,280° C. | 28 |
| Example 2 | Not use loading member | | |

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

1. A metal foam stack, comprising:
two or more stack units,
wherein the stack unit includes:
a first metal foam sheet including an open cell, in which a plurality of internal cells is connected with one another;
a first bonding member positioned on the first metal foam sheet; and
a second metal foam sheet positioned on the first bonding member, and including an open cell, in which a plurality of internal cells is connected with one another,
the metal foam stack includes a first stack unit, a second bonding member positioned on the first stack unit, a heterogeneous member positioned on the second bonding member, a second bonding member positioned on the heterogeneous member, and a second stack unit positioned on the second bonding member,
materials of an interface between the first metal foam sheet and the first bonding member and an interface between the second metal foam sheet and the first bonding member are atomically diffused, and
the heterogeneous member has a different shape or includes a different material from shapes and materials of the first metal foam sheet and the second metal foam sheet.

2. The metal foam stack of claim 1, wherein:
the first bonding member includes at least one of metal powder and brazing foil.

3. The metal foam stack of claim 1, wherein:
the second bonding member includes at least one of metal powder, brazing foil, a ceramic bond, and a metal glue.

4. The metal foam stack of claim 1, wherein:
the first metal foam sheet or the second metal foam sheet includes one or more of Ni-based metal foam, Fe-based metal foam, and Cu-based metal foam.

5. The metal foam stack of claim 1, wherein:
the metal powder is alloy powder, and includes nickel (Ni) of 15 wt % or more or chrome (Cr) of 20 wt % or more.

6. (canceled)

7. (canceled)

8. A method of manufacturing a metal foam stack, comprising:
preparing a first stack unit;
preparing a second stack unit;
forming a metal foam stack including two or more stack units by positioning two layers of second bonding members between the first stack unit and the second stack unit, and positioning a heterogeneous member between the two layers of second bonding members;
applying pre-pressure to the metal foam stack;
applying external pressure to the metal foam stack; and
performing a heat treatment by heating the metal foam stack;
wherein each of the preparing a first stack unit and the preparing a second stack unit includes:
preparing a first metal foam sheet and a second metal foam sheet, each of which includes an open cell, in which internal cells are connected with one another;
forming the first stack unit and the second stack unit by positioning a first bonding member between the first metal foam sheet and the second metal foam sheet;
applying pre-pressure to the first stack unit and the second stack unit;
applying external pressure to the first stack unit and the second stack unit; and
performing a heat treatment by heating the first stack unit and the second stack unit,
materials of an interface between the first metal foam sheet and the first bonding member and an interface between the second metal foam sheet and the first bonding member are atomically diffused, and
the heterogeneous member has a different shape or includes a different material from shapes and materials of the first metal foam sheet and the second metal foam sheet.

9. The method of claim 8, wherein:
the first bonding member includes at least one of metal powder, slurry including metal powder, and brazing foil.

10. (canceled)

11. The method of claim 8, wherein:
the second bonding member includes at least one of metal powder, slurry including metal powder, brazing foil, a ceramic bond, and a metal glue.

12. (canceled)

13. The method of claim 8, wherein:
the applying of the external pressure to the metal foam stack and the performing of the heat treatment by heating the metal foam stack are simultaneously performed, and
the applying external pressure to the first stack unit and the second stack unit and the performing a heat treatment by heating the first stack unit and the second stack unit are simultaneously performed.

14. The method of claim 8, wherein:
the metal powder is alloy powder, and includes nickel (Ni) of 15 wt % or more or chrome (Cr) of 20 wt % or more.

15. The method of claim 9, wherein:
the slurry including the metal powder is slurry for bonding, and
the metal powder of the slurry for bonding includes chrome (Cr) of 30 wt % or more, molybdenum (Mo) of 15 wt % or more, or niobium (Nb) of 3 wt % or more.

16. The method of claim 8, wherein:
the first metal foam sheet or the second metal foam sheet includes one or more of Ni-based metal foam, Fe-based metal foam, and Cu-based metal foam.

17. The method of claim 8, wherein:
the applying of the external pressure to the metal foam stack includes:
disposing a plate on an upper surface of a metal foam sheet positioned at an uppermost portion of the metal foam stack; and
disposing a loading member on the plate so as to load an entire section of the plate.

18. The method of claim 17, wherein:
the plate is formed of a material including one or more of molybdenum (Mo) titanium (Ti), stainless steel, and a ceramic block.

19. The method of claim 8, wherein:
the performing of the heat treatment by heating the metal foam stack includes:
performing debinding of removing a binder ingredient from the metal foam stack; and
sintering the metal foam stack.

20. The method of claim 19, wherein:
the debinding is performed at 500 to 600° C. for one to two hours.

21. The method of claim 19, wherein:
the sintering is performed at 1,100 to 1,300° C. for one to two hours.
